(19) United States
(12) Patent Application Publication
(10) Pub. No.: US 2021/0141634 A1
(43) Pub. Date: May 13, 2021

(54) DEVICE AND METHOD FOR OVER THE AIR UPDATE OF VEHICLE

(71) Applicants: HYUNDAI MOTOR COMPANY, SEOUL (KR); KIA MOTORS CORPORATION, SEOUL (KR)

(72) Inventors: Myeong Gyu JEONG, Seoul (KR); Hyeok Sang JEONG, Seoul (KR); Dong Youl LEE, Seoul (KR)

(73) Assignees: HYUNDAI MOTOR COMPANY, SEOUL (KR); KIA MOTORS CORPORATION, SEOUL (KR)

(21) Appl. No.: 17/035,039

(22) Filed: Sep. 28, 2020

(30) Foreign Application Priority Data
Nov. 12, 2019 (KR) 10-2019-0144602

(51) Int. Cl. G06F 8/65; G06F 8/658; G06F 8/656; G06F 8/71; B60L 58/12; H04W 4/44

(52) U.S. Cl. CPC G06F 8/66; G06F 8/658; H04W 4/44; G06F 8/71; B60L 58/12; G06F 8/656

(57) ABSTRACT

A device and a method for over the air update of a vehicle are provided. The over the air update apparatus of the vehicle may include a communication circuit for receiving data for over the air update of vehicle software from an external server, and a controller configured to store ROMs and update schedules for each control device, for the over the air update, and perform each update using each diagnostic command distinguished for each update schedule based on a safety state of the vehicle.

### CROSS-REFERENCE TO RELATED APPLICATION

The present application claims priority to and the benefit of Korean Patent Application No. 10-2019-0144602, filed on Nov. 12, 2019, the entire contents of which are incorporated herein by reference.

### TECHNICAL FIELD

The present disclosure relates to a device and a method for over the air update of a vehicle, and more particularly, to an update technology for defining a diagnostic command and a sequence for over the air update of a vehicle for each service function, and applying the diagnostic command and the sequence.

### BACKGROUND

The statements in this section merely provide background information related to the present disclosure and may not constitute prior art.

As an intelligent transportation system (ITS) is developed and a proportion of vehicles capable of wireless communication (e.g., a WiFi, a 3G, an LTE, a 5G, an NR SYSTEM, and the like) is increased, communication from a vehicle to an external entity such as another vehicle or an infrastructure is also becoming common.

In addition, the number of electronic control units (ECU) in the vehicle is increasing day by day because of consumer demands and added functions. As a structure and a function of such an electronic control unit becomes more complicated, a software module inside the corresponding electronic control unit also urgently needs an update for the software in the vehicle for bug fix, performance improvement, security improvement, and the like.

In view of such technological development and an industrial service environment, in April 2018, the united nations economic commission for Europe (UNECE) over the air update (OTA) task force (TF) finalized final draft legislation in some countries, such as Europe and Japan, to implement a software update type approval. Meanwhile, in Korea, the Korea automobile testing & research institute (KATRI) is deciding to legalize obligations of OEM and vehicle functions for the OTA of the ECU (expected to come into force in ‘20.2). For example, a section 3.2 of “The vehicle manufacturer shall demonstrate to the Approval Authority the following aspects:”, . . . , a section 3.4 of “The vehicle shall have the following functionality with regards to software updates:”, and the like may be referred to.

In view of such domestic and international circumstances, there is a need for an optimized OTA technology in consideration of standards.

### SUMMARY

An aspect of the present disclosure provides a diagnostic command for over the air update of a vehicle, and a device and a method for transmitting the same.

Another aspect of the present disclosure provides a diagnostic command for over the air update of a vehicle, and a device and a method optimized for transmitting a sequence for the same.

Another aspect of the present disclosure provides an over the air update apparatus and a method of a vehicle that ensure safety and robustness for each scheme.

Another aspect of the present disclosure provides an over the air update apparatus and a method of a vehicle for a new function and optimization.

Another aspect of the present disclosure provides a device and a method for performing software update based on an adaptive command for each technology for over the air update of a vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an over the air update apparatus of a vehicle includes a communication circuit for receiving data for over the air update of vehicle software from an external server, and a controller that controls to store ROMs and update schedules in a manner of distinguishing the ROMs and the update schedules for each control device, for the over the air update, and performs each update using each diagnostic command distinguished for each update schedule in consideration of a safety state of the vehicle.

In one embodiment, the controller may include a management control device including a scheme determining device for determining a scheme of an update target control device, and a master logic for controlling to transfer ROM data in a sequence distinguished based on the determined scheme, and the update target control device for receiving the data from the management control device to perform the over the air update using each diagnostic command based on a scheme determined for each control device.

In one embodiment, the controller may further include a safety determining device for determining whether to perform the update based on a condition determined to perform the over the air update in a safe state of the vehicle, wherein the safety determining device may be included in the management control device.

In one embodiment, the controller may control to perform each update distinguished in consideration of at least one of a default scheme, a differential scheme, a memory dualization scheme, and a scheme combining the differential scheme with the memory dualization scheme.

In one embodiment, the controller may further include a memory for storing data in a manner of distinguishing the data based on a default (general) scheme, a differential scheme, a memory dualization scheme, and a scheme combining the differential scheme and the memory dualization scheme with each other, and wherein the memory may be included in the management control device.

In one embodiment, the update target control device may include at least one of target control devices distinguished based on a default (general) scheme, a differential scheme, a memory dualization scheme, or a scheme for combining the differential scheme and the memory dualization scheme with each other, and the at least one of target control devices may respectively include update execution logics or memories distinguished based on the schemes.

In one embodiment, the server may include data storage for storing each ROM and each update schedule for each control device.

In one embodiment, the controller may control to perform each update using at least one of a command (ReadActiveArea) for controlling to read a memory area currently operating, a command (EraseTargetArea) for controlling to erase a memory area not operating, a command (CopyActiveAreaTo) for controlling to copy the operating memory area to the not operating memory area, and a command (WriteDeltaPatch) for controlling to create a ROM inside the control device based on Delta.

In one embodiment, the controller may control background transfer for the over the air update based on at least one of a network load, a vehicle power state, a battery state, and an estimated remaining ROM data transfer time.

In one embodiment, the controller may complete reprogramming through a command (ReadDataByIdentifier) for controlling to read a software (SW) version of each control device after each update, and then report update success to the server.

According to an aspect of the present disclosure, an over the air update method of a vehicle may include receiving data for over the air update of vehicle software from an external server, and controlling to store ROMs and update schedules in a manner of distinguishing the ROMs and the update schedules for each control device, for the over the air update, and to perform each update using each diagnostic command distinguished for each update schedule in consideration of a safety state of the vehicle.

In one embodiment, the controlling to perform each update may include determining a scheme of an update target control device, and controlling to transfer ROM data in a sequence distinguished based on the determined scheme, and performing the over the air update using each diagnostic command based on a scheme determined based on the received ROM data.

In one embodiment, the controlling to perform each update may further include determining whether to perform the update based on a condition determined to perform the over the air update in a safe state of the vehicle.

In one embodiment, the controlling to perform each update may include controlling to perform each update distinguished in consideration of at least one of a default scheme, a differential scheme, a memory dualization scheme, and a scheme combining the differential scheme with the memory dualization scheme.

In one embodiment, the controlling to perform each update may further include storing data in a memory in a manner of distinguishing the data based on a default (general) scheme, a differential scheme, a memory dualization scheme, and a scheme combining the differential scheme and the memory dualization scheme with each other.

In one embodiment, the controlling to perform each update may further include configuring at least one of target control devices distinguished based on a default (general) scheme, a differential scheme, a memory dualization scheme, or a scheme for combining the differential scheme and the memory dualization scheme with each other, and performing each update based on a corresponding scheme for each of the one or more distinguished target control devices.

In one embodiment, the controlling to perform each update may further include receiving the ROMs and the update schedules based on the control devices from the server.

In one embodiment, the controlling to perform each update may further include performing each update using at least one of a command (ReadActiveArea) for controlling to read a memory area currently operating, a command (EraseTargetArea) for controlling to erase a memory area not operating, a command (CopyActiveAreaTo) for controlling to copy the operating memory area to the not operating memory area, and a command (WriteDeltaPatch) for controlling to create a ROM inside the control device based on Delta.

In one embodiment, the controlling to perform each update may further include controlling background transfer for the over the air update based on at least one of a network load, a vehicle power state, a battery state, and an estimated remaining ROM data transfer time.

In one embodiment, the controlling to perform each update may further include completing reprogramming through a command (ReadDataByIdentifier) for controlling to read a software (SW) version of each control device after each update, and then reporting update success to the server.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of a vehicle system including an over the air update apparatus of a vehicle in one form of the present disclosure;

FIG. 2 is a diagram briefly illustrating a structure of an over the air update system of a vehicle in one form of the present disclosure;

FIG. 3 is a diagram illustrating a system configuration of a vehicle control device in one form of the present disclosure;

FIG. 4 is a diagram illustrating a procedure of performing a default (general) function of a vehicle control device in one form of the present disclosure;

FIG. 5 is a diagram illustrating a procedure of performing a differential function of a vehicle control device in one form of the present disclosure;

FIG. 6 is a diagram illustrating a procedure of performing a memory dualization operation of a vehicle control device in one form of the present disclosure;

FIG. 7 is a diagram illustrating a procedure of performing a differential function and a memory dualization function of a vehicle control device in one form of the present disclosure;

FIG. 8 is a flowchart illustrating a procedure of performing OTAs distinguished based on the OTA functions in one form of the present disclosure; and

FIG. 9 illustrates a computing system in one form of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the tams do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure proposes a required new diagnostic command and a sequence for performing an OTA in a safe and robust manner to practically implement four technologies that perform software update in an over the air update system of a vehicle. The present disclosure determines strengths and weaknesses of the four technologies through sequences and commands such that the four technologies may be applied to a control device, and applies software updated as needed. In addition, the present disclosure discloses a technology of providing a check sequence, which is most suitable in consideration of a case in which a memory in the control device is abnormally operated, and the like.

Hereinafter, embodiments of the present disclosure will be described in detail with reference to FIGS. 1 to 9.

FIG. 1 is a block diagram illustrating a configuration of a vehicle system 10 including an over the air update apparatus of a vehicle according to an embodiment of the present disclosure.

Referring to FIG. 1, an over the air update apparatus 100 of the vehicle according to an embodiment of the present disclosure may perform background transfer of data for over the air update of software of the vehicle from a server 20 outside the vehicle.

The over the air update apparatus 100 of the vehicle may control the background transfer for the over the air update based on at least one of a network load, a vehicle power state, a battery state, and an estimated remaining ROM data transfer time.

In particular, the over the air update apparatus 100 of the vehicle according to the present disclosure may control to perform the over the air update by applying one of default (general)/differential/memory dualization/differential and memory dualization schemes. The over the air update apparatus 100 controls to perform update using a command based on each function for each update. In addition, after the update is successful, the over the air update apparatus 100 may control to read an SW version, identify completion of normal reprogramming, and report the completion of normal reprogramming.

The over the air update apparatus 100 of the vehicle may include a communication circuit 110, storage 120, a display 130, a controller 140, and an alarm device 150.

The communication circuit 110, which is a hardware device implemented with various electronic circuits for transmitting and receiving signals through a wireless or wired connection, may perform in-vehicle communication through a CAN communication, a LIN communication, and an Ethernet communication in the present disclosure. For communication with the server 20 and the like outside the vehicle, the communication circuit 110 may include various communication units of a mobile communication unit, a broadcasting receiving unit such as a DMB module or a DVB-H module, a short-range communication unit such as a ZigBee module or an NEC module, which are Bluetooth modules, a Wi-Fi communication unit, and the like.

The storage 120 may store data downloaded for the over the air update of the vehicle, which is received from the server 20 through the communication circuit 110. In addition, the storage 120 may store at least one of the network load, the vehicle power state, the battery state, and the estimated remaining ROM data transfer time determined by the controller 140. Further, the controller stores a ROM and an OTA scheme for each control device based on one of the default (general)/differential/memory dualization/differential and memory dualization schemes. In this connection, commands for each function may be stored. The storage 120 may include a storage medium of at least one type of memory such as a flash memory type, a hard disk type, a micro type, and a card type (for example, an SD card (Secure Digital Card) or an XD card (eXtream Digital Card)), and the like, and a RAM (Random Access Memory), SRAM (Static RAM), ROM (Read Only Memory), PROM (Programmable ROM), EEPROM (Electrically Erasable PROM), MRAM (Magnetic RAM), a magnetic disk, and an optical disk type memory.

The display 130 may be controlled by the controller 140 to display a screen for user approval for over the air update of the vehicle. The display 130 may be implemented in a head-up display (HUD), a cluster, an AVN (Audio Video Navigation), and the like. Further, the display 130 may include at least one of a liquid crystal display (LCD), a thin film transistor-LCD (TFT LCD), a light emitting diode (LED) display, an organic LED (OLED) display, an active Matrix OLED (AMOLED) display, a flexible display, a bended display, and a three-dimensional (3D) display. Some of these displays may be implemented as transparent displays that are transparent or translucent to allow viewing of the exterior. In addition, the display 130 may be provided as a touch screen including a touch panel, and may be used as an input device in addition to an output device According to the present disclosure, the display 130 may display the completion of the reprogramming and version information to the user.

The controller 140 may be electrically connected to the communication circuit 110, the storage 120, the display 130, the alarm device 150, and the like, and may electrically control each component. The controller 140 may be an electric circuit for executing instructions of the software, and thus, may perform various data processing and calculation to be described later.

The controller 140 may control the background transfer for the over the air update based on at least one of the network load, the vehicle power state, the battery state, and the estimated remaining ROM data transfer time. Further, the controller 140 may perform the over the air update based on default (general)/differential/memory dualization/differential and memory dualization functions.

The controller 140 may determine whether a vehicle mode for the over the air update is a download mode or an update mode, and may determine whether the vehicle is in a traveling state when the vehicle mode is the download mode. When the vehicle is in an ignition off state, the controller 140 may determine whether the vehicle network load is greater than a threshold value. When the vehicle network load is greater than the threshold value, the controller 140 may set a time interval between successive frames to be large and a unit transfer size to be small. Further, when the vehicle network load is equal to or less than the threshold value, the controller 140 may set the time interval between the successive frames to be small and the unit transfer size to be large. The controller 140 may perform the background transfer based on the vehicle network load, and may determine a state of the vehicle when the background transfer is completed. The controller 140 may complete the background transfer when the vehicle state is the ignition off state, and may receive the approval from the user for the over the air update and perform the over the air update when the vehicle state is switched from an ignition on state to the ignition off state when the vehicle state is the ignition on state. When the vehicle is in the ignition on state, the controller 140 may calculate the estimated remaining ROM data transfer time, and determine whether the background transfer is possible in a current battery state for the estimated remaining ROM data transfer time. Further, when the background transfer is available, the controller 140 may determine the network load. The controller 140 may continuously perform the background transfer even when the power state of the vehicle is switched.

In addition, according to the present disclosure, the controller 140 presents specific OTA (including diagnosis) command sequences for the default (general)/differential/memory dualization/differential and memory dualization functions to control an OTA for each function. Diagnostic commands newly added to perform the OTA according to the present disclosure are as follows.

\textcircled{a} ReadActiveArea: a command for reading a memory area currently operating (booting) of A/B memories,

\textcircled{b} EraseTargetArea: a command for erasing one of the A/B memories [exclusible when it is not a NOR flash], which may be applied in a form of erasing a memory that is not currently operating in the OTA,

\textcircled{c} CopyActiveAreaTo: a command for copying a content of the memory A to the memory B, or a content of the memory B to the memory A, which may copy a memory with the currently operating area to a memory that is not operating in the OTA,

\textcircled{d} WriteDeltaPatch: a command for controlling to create the ROM inside the control device based on Delta, not actual ROM transfer

The alarm device 150 may output a notification for approval of the user when displaying the screen for the approval of the user on the display 130.

As such, the present disclosure supports update enhancement through each command based on each function during the vehicle over the air update, and supports background update during a corresponding function, thereby ensuring continuity during the transfer.

FIG. 2 is a configuration diagram of an over the air update system of a vehicle to which the present disclosure is applied.

Referring to FIG. 2, the over the air update apparatus of the vehicle includes an OTA management control device 200 and an OTA target control device 250.

The OTA management control device 200, which is a control device that manages the OTA (Over the air update) update, is a subject that performs the reprogramming by downloading ROM data from the server, and transferring the ROM data to an execution control device. The OTA management control device 200 includes an OTA master 210, a ROLL BACK logic 220, and an update memory 230. In this connection, the OTA master 210 controls to perform the over the air update by applying the default/differential/memory dualization schemes for the reprogramming. In this connection, the OTA master 210 may control to perform the update by determining a network load rate, a ROM load rate. That is, the OTA master 210 controls operation of major OTA functions, such as the update, the background transfer, and the like.

The OTA target control device 250 includes an OTA execution logic 260 and a memory 270 to perform an update (write) operation based on an update request. The OTA execution logic 260 performs the default/differential/memory dualization schemes, and the control device memory 270 stores the ROM data and updated data based on the corresponding function.

FIG. 3 is a diagram illustrating a system configuration of a vehicle control device according to an embodiment of the present disclosure. The present disclosure is to describe four OTA performing technologies as an example. It may exist such that performing of OTA in a combined form for each technology depending on a situation is also available. Each technology has advantages and disadvantages. Thus, a reprogram master logic according to the present disclosure must selectively control an appropriate technology for each OTA target control device in consideration of safety and system efficiency of the vehicle. The present disclosure presents diagnostic commands and sequences for implementing corresponding technologies when performing the four OTAs.

Referring to FIG. 3, an OTA server 390 may include an OTA communicator 392 for performing an OTA communication with the vehicle, data storage for OTA 394 for storing a control device ROM and an OTA scheme of the control device, a ROM registration UI 396 for registering a ROM of an OTA target control device, an OTA history management device 398 for managing whether the OTA is executed and a past history.

A ROM registrant registers a ROM for the OTA target control device and inputs an OTA scheme of the control device.

The OTA device in the vehicle may include the OTA management control device and the OTA target control device.

An OTA management control device 300 includes a communication circuit 305 for performing the OTA communication with the server, a reprogram master logic 310, and a memory 330. In this connection, the reprogram master logic 310 may include a scheme determining device 312 to determine the scheme of the OTA target control device. In addition, the OTA management control device 300 includes a safety determining device 314 to control to perform the OTA by determining whether a condition is satisfied such that the OTA is started in a safe state of the vehicle. In this connection, the memory 330 stores a ROM and an OTA scheme for each control device based on the ROM and the scheme for each control device. The reprogram master logic 310 controls to transmit ROM data in a sequence that matches the determined scheme. As described, the OTA management control device 300 performs the ROM transmission using a sequence/diagnostic command different for each OTA scheme.

An OTA target control device 350 may be formed as units that are distinguished based on the technologies of performing the software update according to an example of the present disclosure. Four OTA target control devices 350, 352, 354, and 356 that are distinguished in consideration of one of the default (general)/differential/memory dualization/differential and memory dualization functions may be arranged according to an example of the present disclosure. In this connection, the OTA target control device for each technology may be added/reduced based on a service environment and the electronic control unit, and depending on a software update version, and the like. OTA execution logic 360 may update (write) the ROM received from the OTA management control device 300 on the memory. In this connection, the update (write) operation is performed in response to a diagnostic command for each function.

Four OTA execution logics 360, 362, 364, and 366 that are distinguished based on the default (general)/differential/memory dualization/differential and memory dualization functions are formed according to an example of the present disclosure. Each of the four OTA execution logics 360, 362, 364, and 366 performs an update operation using a sequence/diagnostic command different for each OTA scheme. The memory 370 stores the ROM data. Further, four memories 370, 372, 374, and 376 that are distinguished based on the default (general)/differential/memory dualization/differential and memory dualization functions are formed according to the present disclosure. Each of the four memories 370, 372, 374, and 376 stores updated data using the sequence/diagnostic command different for each OTA scheme.

The OTA system according to the present disclosure effectively performs the update distinguished by selectively applying the \textcircled{a} ReadActiveArea, the EraseTargetArea, the CopyActiveAreaTo, and the WriteDeltaPatch based on the default (general)/differential/memory dualization/differential and memory dualization functions, that is, for each OTA scheme. Therefore, in a case of control device reprogramming using a vehicle diagnostic apparatus according to an example of the present disclosure, an existing inconvenience, such as a case in which a driver must visit a service center, may be solved. That is, as the ROM for the target control device is registered by the ROM registrant, and the OTA scheme is input accordingly, the software may be updated regardless of a location. For example, Tesla's vehicles perform a new function or optimization through the OTA. Further, in a situation where the control device OTA is already recognized as a major purchase point of the vehicle of consumers, the OTA function according to the present disclosure will be attractive to the consumers.

In addition, when performing the OTA through the command and sequence proposed according to the present disclosure, existing diagnostic specifications (UDS, KWP2000, and the like) solve a disadvantage of no command corresponding to new technology-based reprogramming (differential/memory dualization) for the OTA. In other words, an advantage of developing new diagnostic commands and optimized sequences for the OTA is provided.

Finally, the OTA function according to the present disclosure provides an advantage of ensuring safety and robustness by performing the reprogramming after determining whether the condition set such that the OTA is started in the safe state of the vehicle is satisfied.

Hereinafter, update operations of the default (general)/differential/memory dualization/differential and memory dualization functions according to an example of the present disclosure will be described. In the present disclosure, a command and a sequence of each function distinguished for ease of description are described, but a command and a sequence in a combined form based on a function in a combined form may be proposed as necessary. Therefore, the present disclosure should not be interpreted as being in a form in which the command and the sequence are restricted or limited based on each function to be described.

FIG. 4 is a diagram illustrating a procedure of performing a default (general) function of a vehicle control device according to an embodiment of the present disclosure.

Referring to FIG. 4, first, the ROM and the scheme for updating the OTA target control device are stored in the management control device through the server.

In 410, the controller in the vehicle updates vehicle information based on the wireless communication. Such execution of the update may be associated with stability. To this end, whether the vehicle is in a traveling state or in an ignition off state may be determined. In particular, receiving the approval for the over the air update from the user and performing the over the air update when the vehicle state is switched from the ignition on state to the ignition off state may be included. The ignition on (IG on) state→the ignition off (IG off) state is identified in consideration of a control device (a safety-related control device) with an ASIL rating in the ignition off (IG off) state, that is, a law that the control device in the ignition on state must follow, a measure to exclude the ASIL rating, and the like.

In 420, the controller in the vehicle identifies a safe-status. This is to identify that the vehicle is safe for executing the OTA, including the user approval.

In 430, the controller performs a reprogramming preliminary procedure. That is, the controller performs a preliminary procedure that is the same preliminary procedure as UDS reprogramming through the diagnostic apparatus, and a cooperative control device necessary for the OTA controls to enable a communication with an Enable Normal MSG.

An update procedure is performed in 440. The same procedure as the UDS reprogramming through the diagnostic apparatus may be performed, and after reprogramming through a ReadDataByIdentifier, a RTSW of the control device controls to read the SW version. Therefore, completion of normal reprogramming of the control device may be identified. Thereafter, when the reprogramming is operated normally, the control device reports OTA success to the server. In this connection, a detailed protocol for a newly generated command may be provided when it is necessary.

As described, when performing the update based on the default function, the OTA management device in the vehicle identifies the input OTA scheme based on needs of the user through the scheme determining device, identifies the ignition on/off state through the safety determining device, and consider the situation that the control device must follow and the ASIL level to control the OTA update. In addition, the cooperative control device required for the OTA enables the communication with the Enable Normal MSG, thereby controlling to perform the reprogramming. Thereafter, a completion report on the reprogramming performed normally through the ReadDataByIdentifier is performed.

Thus, a diagnostic reprogramming (UDS) protocol may be utilized as it is, the OTA management control device may act as the diagnostic apparatus, and the reprogramming is performed in a control device boot loader. In this connection, standardization is required due to different reprogramming procedures of the control devices. Further, when the default OTA is executed, the ROM transfer and the reprogramming are executed at the same time. In this case, the control device may not be able to operate during a transmission time, and the transmission time may take up to 20 minutes of EMS, as an example.

As described, there is no H/W change when performing the OTA according to the present disclosure. In a case of S/W, completion of the reprogramming through the ReadDataByIdentifier (command) and version information may be transmitted to user.

FIG. 5 is a diagram illustrating a procedure of performing a differential function of a vehicle control device according to an embodiment of the present disclosure. The differential feature is a scheme for reducing a size of ROM data required for the update.

Referring to FIG. 5, in 500, the controller is in a state in which wireless download is completed, and the ROM and the scheme for updating the OTA target control device are stored in the management control device.

In 510, the controller transmits the ROM from the management control device to the target control device through the background transfer procedure. To this end, the controller may include the management control device that controls the background transfer based on at least one of the network load, the vehicle power state, the battery state, and the estimated remaining ROM data transfer time for the over the air update sets a transfer rate based on the network load, and controls the background transfer based on the set transfer rate and the vehicle state, and the execution control device that receives the data from the management control device to perform the over the air update.

In 520, the controller identifies the ignition on (IG on) state→the ignition off (IG off) state in consideration of the law that the control device in the ignition on state must follow, the measure to exclude the ASIL rating, and the like.

In 530, the controller in the vehicle identifies the safe-status. This is to identify that the vehicle is safe for executing the OTA, including the user approval.

In 540, the controller performs the reprogramming preliminary procedure. That is, the controller performs the preliminary procedure that is the same preliminary procedure as the UDS reprogramming through the diagnostic apparatus, and the cooperative control device necessary for the OTA controls to enable the communication with the Enable Normal MSG.

The controller performs an update procedure in 550. In this connection, \textcircled{a} a Security Access is executed for security test after transition to a Programming session, and \textcircled{b} the WriteDeltaPatch command is additionally generated to control to create the ROM in the control device based on the Delta, not actual the ROM transmission. Thereafter, CheckProgramming Dependency and ECU Reset operations are performed. Thereafter, the RTSW of the control device controls to read the SW version after the reprogramming through the ReadDataByIdentifier according to the present disclosure. Therefore, the completion of the normal reprogramming of the control device is identified. Thereafter, when the reprogramming is operated normally, the control device reports the OTA success to the server. In this connection, the detailed protocol for the newly generated command may be provided when it is necessary.

As described above, the reprogramming may be performed during rebooting after receiving and storing the ROM in the background through the differential function during the operation, so that the time required is shortened (tens of seconds). In one example, a license fee may be incurred for each control device. The differential function according to the present disclosure may be applied when only a changed portion, for example, less than 15%, of an existing ROM is transferred, or reprogramming may be performed by combining the existing ROM and the changed portion with each other. Therefore, as a differential solution is applied to the boot loader from a S/W point of view, a separate ROM transfer protocol is required, and additional flash capacity, for example, about 15% may be needed from a H/W point of view.

FIG. 6 is a diagram illustrating a procedure of performing a memory dualization operation of a vehicle control device according to another embodiment of the present disclosure.

Referring to FIG. 6, in 600, the controller is in the state in which the wireless download is completed, and the ROM and the scheme for updating the OTA target control device are stored in the management control device.

A background transfer procedure in 610 is a process of transferring the ROM from the management control device to the target control device, and three diagnostic commands may be added.

\textcircled{a} The ReadActiveArea: the command for reading the memory area currently operating (booting) of the A/B memories, and \textcircled{b} the EraseTargetArea: the command for erasing one of the A/B memories [exclusible when it is not a NOR flash] may be applied in the form of erasing the memory that is not currently operating in the OTA. Further, \textcircled{c} the CopyActiveAreaTo is the command for copying the content of the memory A to the memory B, or the content of the memory B to the memory A, which is a function of copying the memory with the currently operating area to the memory that is not operating in the OTA. In this connection, when there are a plurality of partitions in the control device memory, the CopyActiveAreaTo command is needed to keep the memory rather than a corresponding area of the OTA up-to-date.

As an example, when A1 and A2 (in operation) and B1 and B2 are present, and only an area 1 is an OTA target, a content of the A2 is copied to the B2, and the B1 is updated through the OTA. In this way, both B1 and B2 may maintain the latest ROM state.

In 620, the controller identifies the ignition on (IG on) state→the ignition off (IG off) state in consideration of the law that the control device in the ignition on state must follow, the measure to exclude the ASIL rating, and the like.

In 630, the controller in the vehicle identifies the safe-status. This is to identify that the vehicle is safe for executing the OTA, including the user approval.

In 640, the controller performs the reprogramming preliminary procedure. That is, the controller performs the preliminary procedure that is the same preliminary procedure as the UDS reprogramming through the diagnostic apparatus, and the cooperative control device necessary for the OTA controls to enable the communication with the Enable Normal MSG.

In 650, the controller performs an update procedure. In this connection, for the memory dualization function, the controller operates to avoid transition to a Programming session to ensure a normal operation of \textcircled{a} the memorydualization OTA target control device. This may operate in an Extended Diagnostic session. The \textcircled{b} CheckProgramming Dependency is performed in advance to prevent swapping into an invalid memory. A new command \textcircled{c} SwapActiveArea may be added to control to change the operating (booting) memory area.

Thereafter, the ECU Reset operation is performed. Thereafter, the RTSW of the control device controls to read the SW version after the reprogramming through the ReadDataByIdentifier according to the present disclosure. Therefore, the completion of the normal reprogramming of the control device is identified. Thereafter, when the reprogramming is operated normally, the control device reports the OTA success to the server. In this connection, the detailed protocol for the newly generated command may be provided when it is necessary.

As described, through the memory dualization function according to the present disclosure, original copy and copy are controlled to remain in internal Flash memory, a copy area is updated during an original copy operation, and an operation is executed in an update area at a next reset time point.

In this connection, control device down time minimization, for example, less than 1 sec is supported. Further, immediate recovery is available when update fail, so that rollback in a separate CCU does not necessarily needed. This provides an advantage of efficiently using the equipped memory when considering cost increase (double memory) of the micro controller unit (MCU).

FIG. 7 is a diagram illustrating a procedure of performing a memory dualization operation combined with a differential function of a vehicle control device according to another embodiment of the present disclosure.

Referring to FIG. 7, in 700, the controller is in the state in which the wireless download is completed, and the ROM and the scheme for updating the OTA target control device are stored in the management control device.

A background transfer procedure in 710 is a process of transferring the ROM from the management control device to the target control device, and four diagnostic commands may be added. \textcircled{a} The ReadActiveArea: the command for reading the memory area currently operating (booting) of the A/B memories, and \textcircled{b} the EraseTargetArea: the command for erasing one of the A/B memories [exclusible when it is not a NOR flash] may be applied in the form of erasing the memory that is not currently operating in the OTA. Further, \textcircled{c} the CopyActiveAreaTo is the command for copying the content of the memory A to the memory B, or the content of the memory B to the memory A, which is a function of copying the memory with the currently operating area to the memory that is not operating in the OTA. In this connection, when there are a plurality of partitions in the control device memory, the CopyActiveAreaTo command is needed to keep the memory rather than a corresponding area of the OTA up-to-date. As an example, when the A1 and the A2 (in operation) and the B1 and the B2 are present, and only the area 1 is the OTA target, the content of the A2 is copied to the B2, and the B1 is updated through the OTA. In this way, both B1 and B2 may maintain the latest ROM state. Further, \textcircled{d} the WriteDeltaPatch creates the ROM in the control device based on the Delta rather than the actual ROM transfer.

In 720, the controller identifies the ignition on (IG on) state→the ignition off (IG off) state in consideration of the law that the control device in the ignition on state must follow, the measure to exclude the ASIL rating, and the like.

In 730, the controller in the vehicle identifies the safe-status. This is to identify that the vehicle is safe for executing the OTA, including the user approval.

In 740, the controller performs the reprogramming preliminary procedure. That is, the controller performs the preliminary procedure that is the same preliminary procedure as the UDS reprogramming through the diagnostic apparatus, and the cooperative control device necessary for the OTA controls to enable the communication with the Enable Normal MSG.

In 750, the controller performs the update procedure. In this connection, for the memory dualization function, the controller operates to avoid transition to the Programming session to ensure the normal operation of \textcircled{a} the memorydualization OTA target control device. This may operate in the Extended Diagnostic session. The \textcircled{b} CheckProgramming Dependency is performed in advance to prevent swapping into the invalid memory. The new command \textcircled{c} SwapActiveArea may be added to control to change the operating (booting) memory area.

Thereafter, the ECU Reset operation is performed. Thereafter, the RTSW of the control device controls to read the SW version after the reprogramming through the ReadDataByIdentifier according to the present disclosure. Therefore, the completion of the normal reprogramming of the control device is identified. Thereafter, when the reprogramming is operated normally, the control device reports the OTA success to the server. In this connection, the detailed protocol for the newly generated command may be provided when it is necessary.

As described, the present disclosure presents the new diagnostic command for practical implementation of the four technologies of performing the software updates, and the sequence for safely and robustly proceeding the OTAs. The present disclosure may determine the strengths and the weaknesses of the four technologies to selectively apply the four technologies to the control device, so that a sequence and a command based on a corresponding function may be selectively applied. In addition, the present disclosure provides the check sequence in consideration of the abnormal operation of the memory in the control device.

Thus, the present disclosure proposes the specific method for distributing the control device OTA, and improvement of the marketability of the vehicle to be described below is available through the OTA. In other words, as an OTA application field, additional improvement of a marketability for a sold vehicle, which is operated by a customer, and improvement of a marketability in case of a S/W quality problem are available.

In addition, when a high performance control device is installed in the future, when an additional S/W function and the like are expected, although a development is currently in progress as a H/W configuration optimized for a current function in consideration of cost, improvement of efficiency for coping with quality problems for uniform update of an UX, such as a cluster, a HUD, an AVN, and the like, addition of an ADAS/autonomous driving function, control device performance update based on a customer's preference, and the like may be supported later. In addition, an advantage of collaborating with a service business division through reducing sold vehicle update cost by securing a S/W update convenience is provided.

Hereinafter, a vehicle control method according to another embodiment of the present disclosure will be described in detail with reference to FIG. 8. FIG. 8 is a flowchart for illustrating a vehicle control method according to another embodiment of the present disclosure.

Hereinafter, it is assumed that the vehicle over the air update apparatus 100 of FIG. 1 performs processes of FIG. 8. In addition, in a description of FIG. 8, operations described as being performed by the device may be understood to be controlled by the controller 140 of the vehicle over the air update apparatus 100.

FIG. 8 is a flowchart illustrating a procedure of performing OTAs distinguished based on the OTA functions according to the present disclosure.

Referring to FIG. 8, the controller receives the registered ROM for the OTA target control device and the OTA scheme of the corresponding control device (S800).

The controller stores the ROM and the OTA scheme for each control device based on the ROM and scheme for each control device (S810), identifies the ROM data fit for the requested OTA (S815), and controls to execute the OTA by identifying the safety state of the vehicle, a determined condition, a backgrou nd condition, and the like (S820).

Thereafter, the controller performs the ROM transfer using the sequence/diagnostic command different for each OTA scheme (S825). According to an example of the present disclosure, the four OTA functions distinguished in consideration of one of the default (general)/differential/memory dualization/differential and memory dualization functions are provided. This may be added depending on the service environment and the provision of the electronic control unit.

The controller identifies the transferred ROM and performs the update (writing) operation in response to the diagnostic command for each function (S835).

FIG. 9 illustrates a computing system according to an embodiment of the present disclosure.

With reference to FIG. 9, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in a hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

The present technology provides an advantage of presenting the diagnostic command for the new function for performing the software update and the sequence that is safe and supports system robustness.

Further, the advantages and disadvantages of the technologies based on the functions to be updated may be determined and the technologies may be selectively applied to the control device, so that update and product enhancements are provided.

In addition, whether the update is normal is determined and reported, so that a false operation and a normal operation of the system may be provided to the user more efficiently.

Finally, the specific method for distributing the control device OTA is proposed, thereby ensuring improvement of a marketability of the vehicle as much as possible.

In addition, various effects, directly or indirectly understood through the present specification, may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An over the air update apparatus of a vehicle, the over the air update apparatus comprising:
a communication circuit configured to receive data for over the air update of vehicle software from an external server; and
a controller configured to:
store ROMs and update-schedules for the over the air update; and
perform each update using each diagnostic command based on a safety state of the vehicle.

2. The over the air update apparatus of claim 1, wherein the controller comprises:
a management control device comprising:
a scheme determining device configured to determine a scheme of an update target control device; and
a master logic configured to transfer ROM data in a sequence distinguished based on the determined scheme; and
the update target control device configured to receive the data from the management control device to perform the over the air update using each diagnostic command based on a scheme determined for each control device.

3. The over the air update apparatus of claim 2, wherein the controller further comprises:
a safety determining device configured to determine whether to perform the update based on a condition determined to perform the over the air update in a safe state of the vehicle,
wherein the safety determining device is included in the management control device.

4. The over the air update apparatus of claim 1, wherein the controller is configured to:
perform each update based on at least one of a default scheme, a differential scheme, a memory dualization scheme, or a scheme combining the differential scheme with the memory dualization scheme.

5. The over the air update apparatus of claim 2, wherein the controller further comprises:
a memory configured to store data based on a default scheme, a differential scheme, a memory dualization scheme, and a scheme combining the differential scheme and the memory dualization scheme with each other, and
wherein the memory is included in the management control device.

6. The over the air update apparatus of claim 2, wherein the update target control device comprises at least one of target control devices distinguished based on a default scheme, a differential scheme, a memory dualization scheme, or a scheme for combining the differential scheme and the memory dualization scheme with each other, and
wherein the at least one of target control devices respectively include update execution logics or memories distinguished based on the schemes.

7. The over the air update apparatus of claim 1, wherein the server comprises:
data storage configured to store each ROM and each update schedule for each control device.

8. The over the air update apparatus of claim 1, wherein the controller is configured to perform each update using at least one of a command (ReadActiveArea) for controlling to read a memory area currently operating, a command (EraseTargetArea) for controlling to erase a memory area not operating, a command (CopyActiveAreaTo) for controlling to copy the operating memory area to an unoperating memory area, and a command (WriteDeltaPatch) for controlling to create a ROM inside the control device based on Delta.

9. The over the air update apparatus of claim 1, wherein the controller is configured to:
control background transfer for the over the air update based on at least one of a network load, a vehicle power state, a battery state, or an estimated remaining ROM data transfer time.

10. The over the air update apparatus of claim 1, wherein the controller is configured to:
complete reprogramming through a command (ReadDataByIdentifier);
read a software (SW) version of each control device after each update; and
report update success to the server.

11. An over the air update method of a vehicle, the over the air update method comprising:
receiving data for over the air update of vehicle software from an external server;
storing ROMs and update schedules for the over the air update; and
performing each update using each diagnostic command distinguished for each update schedule based on a safety state of the vehicle.

12. The over the air update method of claim 11, wherein performing each update includes:
determining a scheme of an update target control device, and controlling to transfer ROM data in a sequence based on the determined scheme; and
performing the over the air update using each diagnostic command based on a scheme determined based on the received ROM data.

13. The over the air update method of claim 12, wherein performing each update further includes:
determining whether to perform the update based on a condition determined to perform the over the air update in a safe state of the vehicle.

14. The over the air update method of claim 11, wherein performing each update includes:
performing each update distinguished based on at least one of a default scheme, a differential scheme, a memory dualization scheme, or a scheme combining the differential scheme with the memory dualization scheme.

15. The over the air update method of claim 12, wherein performing each update further includes:
storing data in a memory based on a default scheme, a differential scheme, a memory dualization scheme, and a scheme combining the differential scheme and the memory dualization scheme with each other.

16. The over the air update method of claim 12, wherein performing each update further includes:
configuring at least one of target control devices distinguished based on a default scheme, a differential scheme, a memory dualization scheme, and a scheme for combining the differential scheme or the memory dualization scheme with each other; and
performing each update based on a corresponding scheme for each of a plurality of distinguished target control devices.

17. The over the air update method of claim 11, wherein performing each update further includes:
receiving the ROMs and the update schedules based on the control devices from the server.

18. The over the air update method of claim 11, wherein performing each update further includes:
performing each update using at least one of a command (ReadActiveArea) for controlling to read a memory area currently operating, a command (EraseTargetArea) for controlling to erase a memory area not operating, a command (CopyActiveAreaTo) for controlling to copy the operating memory area to the not operating memory area, or a command (WriteDeltaPatch) for controlling to create a ROM inside the control device based on Delta.

19. The over the air update method of claim 11, wherein performing each update further includes:
controlling background transfer for the over the air update based on at least one of a network load, a vehicle power state, a battery state, or an estimated remaining ROM data transfer time.

20. The over the air update method of claim 11, wherein performing each update further includes:
completing reprogramming through a command (ReadDataByIdentifier) for reading a software (SW) version of each control device after each update, and then reporting update success to the server.
